(19) United States
(12) Patent Application Publication
(10) Pub. No.: US 2023/0141806 A1
(43) Pub. Date: May 11, 2023

(54) SYSTEMS AND METHODS FOR PROVIDING AN INTEGRATED PLATFORM FOR SECURE PRODUCT LABELLING, VERIFICATION, AND ENFORCEMENT

(71) Applicant: MYORI SERVICES SDN. BHD., Wilayah Persekutuan (MY)

(72) Inventors: Ken Ji LING, Petaling Jaya (MY); Zul Imran BIN ABDUL RAHAMAN, Puchong (MY); Ahmad Fuad BIN MOKHTAR, Puchong (MY)

(21) Appl. No.: 17/981,490

(22) Filed: Nov. 7, 2022

(30) Foreign Application Priority Data
Nov. 8, 2021 (MY) PI2021006668

(51) Int. Cl. G06Q 30/00; G06Q 30/02

(52) U.S. Cl. CPC G06Q 30/0185; G06Q 30/0201; G06Q 30/0282

(57) ABSTRACT

A method for providing an integrated platform for secure product labelling, verification, and enforcement, includes the steps of providing multiple first labels and multiple second labels aimed at labelling a multiple products to be labelled, verified and protected; providing an online platform to be used by one or more enforcement agencies for monitoring activities of each product of the multiple products in the market, receiving complaints or reports directly from consumers and get data analysis reports pertaining to the multiple products, and, supporting multi-agency collaboration activities. In use, the information sharing between agencies will become easier, thereby increasing their work efficiency.

### CROSS REFERENCE TO RELATED APPLICATIONS

This application claims priority to Malaysian Application No. P12021006668 filed on Nov. 8, 2021, the entire contents of which are herein incorporated by reference in its entirety.

### TECHNICAL FIELD

Embodiments of the present invention generally relate to the field of data processing, and, more particularly, to systems and methods for providing an integrated platform for secure product labelling, verification, and enforcement.

### BACKGROUND OF INVENTION

Generally, as it is known that fake replicas of real products known as counterfeits are being produced with the intention to avail the superior value of the imitated product. Furthermore, in other words, counterfeits are commonly called ‘Knock offs’ or ‘fake goods’ and are emulated or fake replicas of the real products.

Furthermore, counterfeit products that are sold online, costs a lot to the enterprises selling real products, which further damages these enterprises at multiple levels. Moreover, these counterfeit products not only affect the revenue or sale but also impacts the customer relationship and branding. Also, these counterfeit products sold online can cause health and safety issues, thus affecting the real brands negatively. To tackle counterfeit issues many conventional techniques were used that heavily depended on manual intervention due to lack of automated solutions capable of searching, classifying and taking actions against counterfeit products online.

In accordance with the conventional disclosures, that discloses the labelling of products with hologram stickers or QR Codes and sometimes even both. However, it is difficult to differentiate between a genuine and a fake hologram label because it depends entirely on visuals and consumers can be easily duped into buying fake products.

Additionally, in accordance with prior art disclosure, that discloses the use of radio-frequency identification (RFID) transponder or other embedded trigger technology within a sewn-in label that are incorporated into or attached to articles to be tracked. These RFID tags are manufactured with a unique identification number that cannot be altered by the user and is used only once. Further, the RFID tag is read-only and it responds to an interrogation signal only with its identification number. However, these tags may be removed with rough handling.

Furthermore, in accordance with the conventional disclosures, various anti-counterfeiting techniques have been disclosed that involve laser anti-counterfeiting, electronic code anti-counterfeiting, QR code anti-counterfeiting, RFID anti-counterfeiting, NFC anti-counterfeiting, and blockchain traceability. However, these weak anti-counterfeiting capabilities.

Additionally, in accordance with the conventional disclosures, many anti-counterfeiting labels or marks have been used to distinguish brand-name products from the counterfeit products. There are many types of anti-counterfeit labels, including holographic anti-counterfeit labels, graphic-output laser anti-counterfeit labels, shape memory anti-counterfeit labels, hand tags, care labels and the like. However, these tags or labels are typically sticker attached to the exterior of the product, and may become detached with rough handling, or deliberately removed. Further, typical care labels are required to contain a large amount of information and it is difficult to fit in all of the information on a care label or hang tag.

Furthermore, there are prior art disclosures wherein NFC (Near Field Communication) chips are incorporated onto the labels, making them unique anti-counterfeiting labels; these labels cannot be transferred to other similar products. However, the pasting; objects of the existing labels are diversified, and the existing labels cannot meet the demand for such diversified pasting.

Moreover, there are various disclosures wherein quality anti-counterfeiting methods including anti-counterfeit labels plus two dimensional code, combined with quality management systems have been disclosed. This method includes scanning two dimensional code via mobile phones by the consumers to obtain relevant product quality inspection reports and to identify the authenticity of the product via phone or web page security code query. However, some merchants can fake the website content, use the similar type of anti-counterfeiting labels with the intention to imitate the real ones, which cannot further be distinguished by the consumer or quality supervision.

Additionally, in accordance with the prior art disclosure that discloses a double ID anti-counterfeiting method and system, wherein two kinds of anti-counterfeiting codes are used, the first code is a retailer's code and second code is a product code. Further, both of these codes must be provided to an authenticated server to authenticate the tag. However, the disadvantage of using this anti-counterfeiting method is that the retailer has already been determined before leaving the product, thus limiting the freedom of choice of the retailer.

Therefore, there is a need for an integrated platform that provides product labelling, verification, authentication and enforcement. An improved method designed to Litigate the above challenges of counterfeit products for all stakeholders, consumers, retailers, manufacturers and regulators. Overall, a system that could easily track product shipments and inventory, that provides quick and accurate assessments about the distribution of the product, provide consumers with up-to-date information on authenticity, manufacturing standards, compliance status, & product recall information and useful reports and analysis to the authorities. Accordingly, there remains a need m the art for innovative, novel, cost-effective and efficient solutions providing systems and methods for providing an integrated platform for secure product labeling, verification, and enforcement.

### SUMMARY OF THE INVENTION

It is an object of the invention to provide systems and methods for providing an integrated platform for secure product labelling, verification, and enforcement.

In one embodiment, a method for providing an integrated platform for secure product labelling, verification, and enforcement, includes the steps of, providing multiple first labels and multiple second labels aimed at labelling a multiple products to be labelled, verified and protected; providing an online platform to be used by one or more enforcement agencies for monitoring activities of each product of the multiple products in the market, receiving complaints or reports directly from consumers and get data analysis reports pertaining to the multiple products, and, supporting multi-agency collaboration activities. In use, the information sharing between agencies will become easier, thereby increasing their work efficiency.

The embodiments of the present disclosure have several features, no single one of which is solely responsible for their desirable attributes. Without limiting the scope of the present embodiments as expressed by the claims that follow, their more prominent features will now be discussed briefly. After considering this discussion, and particularly after reading the section entitled “Detailed Description”, one will understand how the features of the present embodiments provide advantages, which include systems and methods for providing an integrated platform for secure product labelling, verification, and enforcement.

### BRIEF DESCRIPTION OF DRAWINGS

Various embodiments of the present invention are disclosed herein below, which relate to systems and methods for providing. an integrated platform for secure product labelling, verification, and enforcement.

FIG. 1A, FIG. 1B, FIG. 1C, FIG. 1D, FIG. 1E, FIG. 1F, FIG. 1G, and, FIG. 1H, illustrate various aspects of the system and method for providing an integrated platform for secure product labelling, as per one embodiment of the instant invention. In accordance with an embodiment of the present invention, a method for providing an integrated platform for secure product labelling, verification, and enforcement, includes the steps of, providing multiple first labels and multiple second labels aimed at labelling a multiple products to be labelled, verified and protected; providing an online platform to be used by one or more enforcement agencies for monitoring activities of each product of the multiple products in the market, receiving complaints or reports directly from consumers and get data analysis reports pertaining to the multiple products, and, supporting multi-agency collaboration activities. in use, the information sharing between agencies will become easier, thereby increasing their work efficiency.

In accordance with an embodiment of the present invention, the method fluffier includes the step of providing an application resource installed on a user device associated with a user. In use, the application resource includes, a label scanner module for identifying authentic and/or counterfeit labels from the multiple first labels and/or the multiple second labels, a reporting module for recording findings of the application resource during raids and/or spot checks, and, a retailer module to allow a multiple retailers to receive and scan the multiple products.

In accordance with an embodiment of the present invention, the first labels include NFC labels and the second labels include QR codes. In use, NFC labels enables the MyORI SmartSecure Platform to easily track product shipments and inventory, leaning that quick and accurate assessments can be made about the distribution of the product. In further use, the MyORI SmartSecure Platform can track QR Code usage which can capture where and when the QR Code was scanned. Using this method, it will solve the issue of counterfeiters from reproducing the QR Codes. Also, by implementing the MyORI SmartSecure Platform, QR Code can once again be used as a smart & secure product labelling option.

In accordance with an embodiment of the present invention, the encrypted MyORI SmartSecure Labels can consolidate the labelling of goods and provide consumers with up-to-date information on authenticity, manufacturing standards & compliance status, as well as recall information and the ability to easily provide authorities with useful reports if anything is amiss.

In accordance with an embodiment of the present invention, the method further includes the step of upgrading existing Regulatory Labels with secure, encrypted labels via the multiple first labels and or the multiple second labels. Operationally, the methods and systems as disclosed herein are aimed at preventing counterfeits, duty-unpaid and non-conforming products from being sold as legitimate or approved products.

In accordance with an embodiment of the present invention, the methods and systems of the present invention are built and/or implemented using Near Field Communication (NFC) technology. In use, the systems and methods as disclosed herein are configured to be used only on products that comply with the manufacturing standards and regulatory body requirements.

In accordance with an embodiment of the present invention, a system for providing an integrated platform for secure product labelling, verification, and enforcement, includes, a plurality of first labels and a plurality of second labels aimed at labelling a plurality of products to be labelled, verified and protected; an online platform to be used by at least one enforcement agency for monitoring activities of each product of said plurality of products in the market, receiving complaints or reports directly from consumers and get data analysis reports pertaining to said plurality of products, and, supporting a plurality of multi-agency collaboration activities; an application resource installed on a user device associated with a user, said application resource including, a label scanner module for identifying authentic and I or counterfeit labels from said plurality of first labels and/or said plurality of second labels, a reporting module for recording findings of said application resource during raids and/or spot checks, and, a retailer module to allow a plurality of retailers to receive and scan said plurality of products.

### EMBODIMENTS

Those of ordinary skills in the art will appreciate that NFC and OR Code are not newfound technologies while any experienced IT company are able to create a software or system, hut the systems and methods of the present invention are aimed at providing the MyORI SmartSecure Platform as a solution to have successfully combined the two elements to create a complete brand protection ecosystem.

In use, under the MyORI SmartSecure Platform, each stakeholder; consumers, retailers, manufacturers (brand owner) and regulators (enforcement agencies) are actively working, together to identify counterfeit products & prevent suspicious activities in the market.

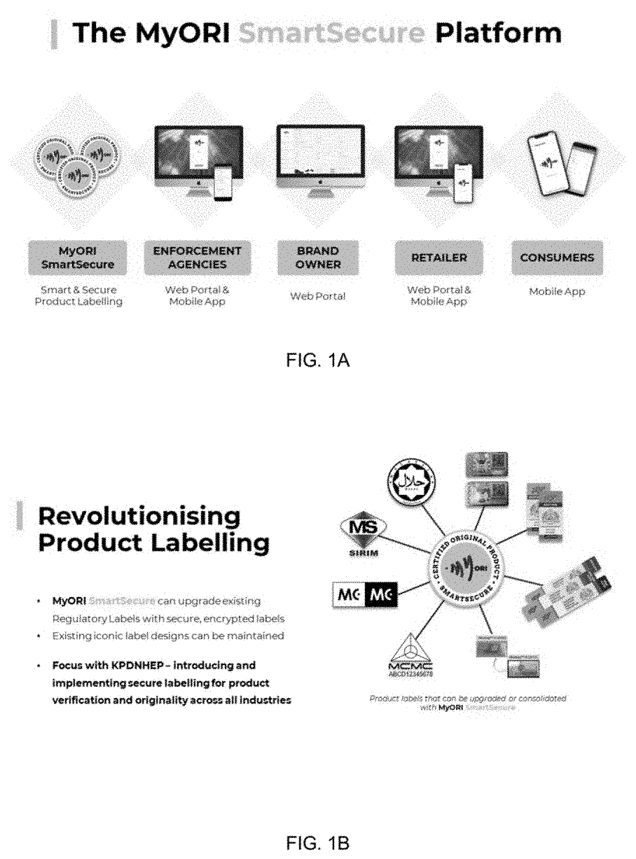

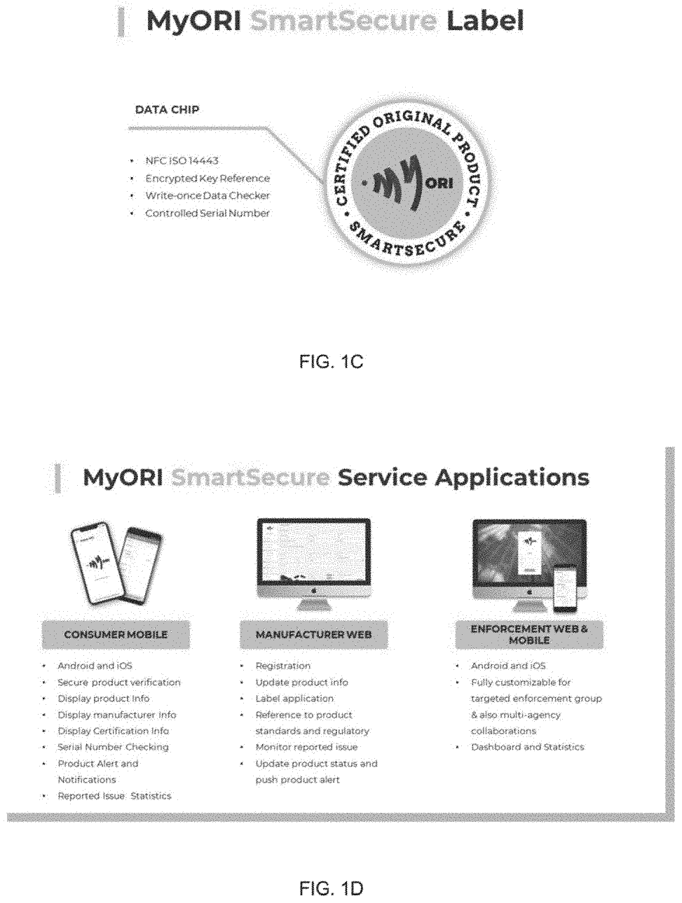

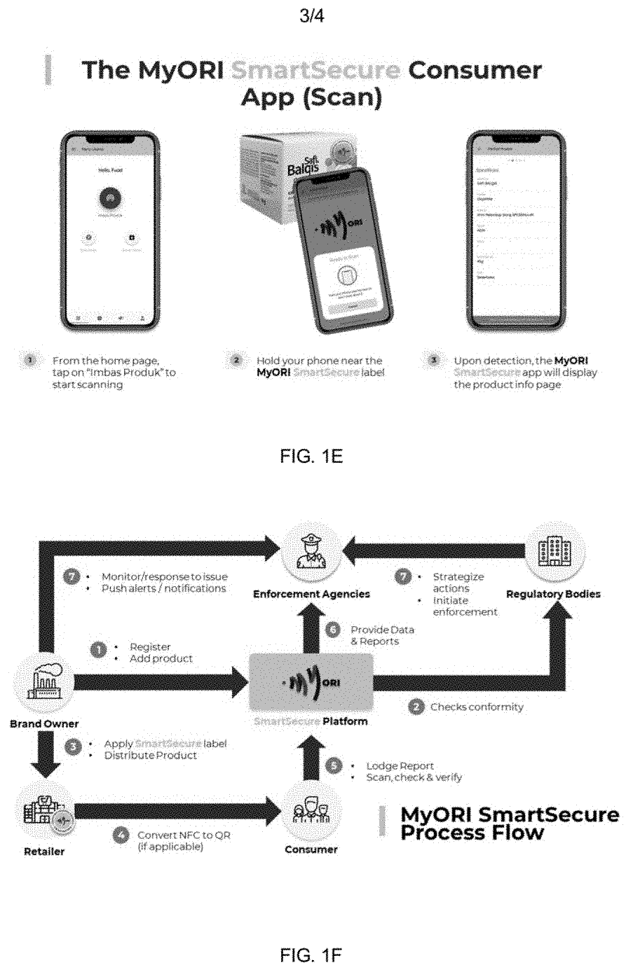

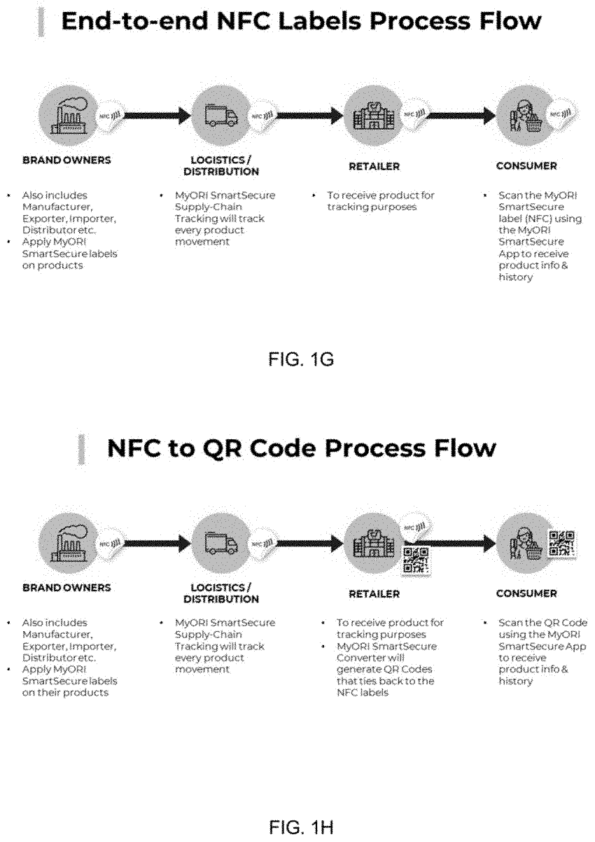

As illustrated in FIG. 1F, the MyORI SmartSecure Process Flow firstly provides an interface to a Brand Owner to register their business to be part of the platform. After a successful registration process, Brand Owner must provide detailed information on the products that they wish to protect. Any information related to product certifications will be check with the respective Regulatory Bodies to ensure proper compliance. After a successful product registration, Brand Owners will receive the MyORI SmartSecure Labels to be applied on their products before the distribution process.

Subsequently, retailers will then receive the products for sale. With the use of the MyORI SmartSecure Converter, Retailers can then generate QR Code for each sale transaction. This process is only applicable to certain products.

Also, by using the MyORI SmartSecure Consumer App, consumers can receive detailed product info and can lodge a report directly from the app if they notice any suspicious activity. In use, each complaint & reports made by the consumer will then be collected and send directly to the respective Enforcement Agencies. Enforcement Agencies can receive & view all this data through the MyORI SmartSecure Enforcement Agency App. The case management system included in the app will allow them to easily manage each report. they receive and assigned them to their enforcement officers. Through the application resource, Brand Owners that are involved can easily be contacted & notified by the Enforcement Agencies for enquiries or investigation purposes. They can also monitor each product under the MyORI SmartSecure program through the app.

In addition, the MyORI SmartSecure labels can upgrade existing Regulatory Labels with secure, encrypted labels in order to prevent counterfeits, duty-unpaid and non-conforming products from being sold as legitimate or approved products. Existing iconic label designs (KPDNHEP TULEN hologram, SIRIM MS, MCMC label, HALAL JAKIM, JKDM Duty-Paid) can be maintained to ensure consumer familiarity and trust is not lost, while other labels can be consolidated if deemed appropriate, as illustrated in FIG. 1C.

In accordance with an embodiment of the present invention, by having both NFC & QR Codes, MyORI SmartSecure offers 2 types of labelling process flow to cater to the various kind of products in the market, as illustrated in FIG. 1G for End-to-end NFC label, and as further illustrated in FIG. 1H for NFC to QR Codes.

Those of ordinary skill in the art will appreciate that systems and methods of the present invention provide significant advantages over the prior art, including, but not limited to, encrypted SmartSecure Labels that can consolidate the labelling of goods, providing consumers with up-to-date information on authenticity, manufacturing standards, compliance status, & product recall information, providing authorities with useful reports & analysis, and the like.

Those of ordinary skill in the art will appreciate that the systems and methods as disclosed herein by way of exemplary embodiments are embodied via an exemplary system for providing an integrated platform for secure product labelling, verification, and enforcement. In use, said system includes multiple user devices, each of which hosts a number of applications including a user application resource. In further use, each user application resource is communicatively coupled to other instances of the user application resources and a server system via said communication network (e.g. the Internet).

As used herein, the term “user device” may refer to any machine that interfaces to said communications network to obtain resources from one or more server systems or other user devices. In use, a user device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

In accordance with an embodiment of the present invention, the communication network may include, or operate in conjunction with, an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fit network, another type of network, or a combination of two or more such networks.

In accordance with an embodiment of the present invention, the communication network or a portion of the communication network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

accordance with an embodiment of the present invention, the systems and methods as disclosed herein are aimed at providing server-side functionality via the communication network to a user application resource aimed at providing systems and methods for providing an integrated platform for secure product labelling, verification, and enforcement.

Those of ordinary skill in the art will further appreciate that while certain functions of the system are described herein as being performed by either a user application resource or by the server system, it will be appreciated that the location of certain functionality either within the user application resource or the server system is a design choice. For example, it may be technically preferable to initially deploy certain technology and functionality within the server system, but to later migrate this technology and functionality to the user application resource where a user device has a sufficient processing capacity.

In accordance with an embodiment of the present invention, the server system supports various services and operations that are provided to the user application resource. Such operations include transmitting data to, receiving data from, and processing data generated by the user application resource. This data may include, message content, user device information, geolocation information, media annotation and overlays, message content persistence conditions, social network information, and live event information, as examples. Those of ordinary skill in the art will further appreciate that data exchanges within the system are invoked and controlled through functions available via user interfaces (UIs) of the user application resource, as disclosed herein.

Those of ordinary skills in the art will appreciate that the systems and methods in according to present invention may be embodied as mobile application or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. Therefore, as may be seen, various embodiments of the present invention as disclosed hereinabove provide significant advantages over prior art, such as, for example, but not limited to, the aspects disclosed hereinabove.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be per formed any particular embodiment. The terms “comprising,” “including,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith. Therefore, the appended claims are be construed to cover all equivalents falling within the true scope and spirit of the invention.

What is claimed is:

1. A method for providing an integrated platform for secure product labelling, verification, and enforcement, said method comprising the steps of:
providing a plurality of first labels and a plurality of second labels aimed at labelling a plurality of products to be labeled, verified and protected;
providing an online platform to be used by at least one enforcement agency for monitoring activities of each product of said plurality of products in the market, receiving complaints or reports directly from consumers and get data analysis reports pertaining to said plurality of products, and, supporting a plurality of multi-agency collaboration activities; and
providing an application resource installed on a user device associated with a user, said application resource including, a label scanner module for identifying authentic and/or counterfeit labels from said plurality of first labels and/or said plurality of second labels, a reporting module for recording findings of said application resource during raids and or spot checks, and, a retailer module to allow a plurality of retailers to receive and scan said plurality of products.

2. The method as claimed in claim 1, wherein said plurality of first labels include NFC labels and said plurality of second labels include QR codes.

3. The method as claimed in claim 1, wherein said method further comprises the step of upgrading existing Regulatory Labels with secure, encrypted labels via said plurality of first labels and/or said plurality of second labels.

4. The method as claimed in claim 1, wherein said method provides a system built on Near Field Communication (NFC) technology.

5. The method as claimed in claim 1, wherein said method is configured to be used only on products that comply with the manufacturing standards and regulatory body requirements.

6. A system for providing an integrated platform for secure product labelling, verification, and enforcement, said system comprising:
a plurality of first labels and a plurality of second labels aimed at labelling a plurality of products to be labelled, verified and protected;
an online platform to be used by at least one enforcement agency for monitoring activities of each product of said plurality of products in the market, receiving complaints or reports directly from consumers and get data analysis reports pertaining to said plurality of products, and, supporting a plurality of multi-agency collaboration activities; and
an application resource installed on a user device associated with a user, said application resource including, a label scanner module for identifying authentic and/or counterfeit labels from said plurality of first labels and/or said plurality of second labels, a reporting module for recording findings of said application resource during raids and/or spot checks, and, a retailer module to allow a plurality of retailers to receive and scan said plurality of products.

7. The system as claimed in claim 6, wherein said plurality of first labels include NFC labels and said plurality of second labels include QR codes.

8. The system as claimed in claim 6, wherein said system is configured to upgrade existing Regulatory Labels with secure, encrypted labels via said plurality of first labels and/or said plurality of second labels.

9. The system as claimed in claim 6, wherein said system link on Near Field Communication (NFC) technology.

10. The system as claimed in claim 6, wherein said system is configured to be used only on products that comply with the manufacturing standards and regulatory body requirements.
